(19) United States
(12) Patent Application Publication
(10) Pub. No.: US 2021/0215901 A1
(43) Pub. Date: Jul. 15, 2021

(54) LENS APPARATUS AND IMAGE PICKUP APPARATUS

(71) Applicant: CANON KABUSHIKI KAISHA, Tokyo (JP)

(72) Inventor: Kazuhiro Honobe, Saitama (JP)

(21) Appl. No.: 17/142,439

(22) Filed: Jan. 6, 2021

(30) Foreign Application Priority Data
Jan. 14, 2020 (JP) 2020-003660

(51) Int. Cl. G02B 7/04; H04N 5/225; G02B 15/10

(52) U.S. Cl. CPC G02B 7/04; G02B 15/10; H04N 5/2254

(57) ABSTRACT

Provided is a lens apparatus including: a lens unit configured to be movable for flange back adjustment; a driving device configured to drive the lens unit; a position detector configured to detect a position of the lens unit; a state detector configured to detect a state of the lens apparatus; a memory configured to store a first state detected by the state detector at a time when the flange back adjustment is performed; and a controller configured to control the driving device based on the first state, a second state of the lens apparatus detected by the state detector, and the position of the lens unit detected by the position detector.

### BACKGROUND OF THE INVENTION

### Field of the Invention

The present invention relates to a lens apparatus and an image pickup apparatus.

### Description of the Related Art

In general, in a case where a lens apparatus and an image pickup apparatus main body are separable for replacement, a flange back length is designed to have a correct value irrespective of the combination of the lens apparatus and the image pickup apparatus main body. However, due to a variation in physical characteristics of optical elements and an error in manufacturing of components, for example, the flange back length may deviate. In that case, in a zoom lens, a focus deviation may occur accompanying a change in focal length. In a zoom lens for taking a moving image, the focus deviation accompanying zooming may be a serious problem.

In Japanese Patent Application Laid-Open No. H06-94966, there is disclosed an optical apparatus in which a lens unit is moved in an optical axis direction to compensate for the deviation in flange back length (flange back adjustment).

When the combination of the lens apparatus and the image pickup apparatus main body is the same, once the flange back is adjusted, images are often taken continuously without repeating the adjustments. However, when a videographic environment, for example, a temperature, a humidity, or an atmospheric pressure significantly changes, the back focal length may be changed due to a change in dimension of the components such as the optical elements or a change in refractive index of air (medium before and after a lens), for example.

Also when an elevation angle of the lens apparatus is significantly changed, an interval between the components, for example, may be changed due to the effect of gravity, and hence the back focal length may be changed. When the back focal length is changed, the focus deviation accompanying zooming may occur as in the case in which the flange back length deviates. As a result, with the optical apparatus disclosed in Japanese Patent Application Laid-Open No. H06-94966, images may be taken even when the back focal length has been changed after the flange back adjustment.

### SUMMARY OF THE INVENTION

An aspect of embodiments provides, for example, a lens apparatus beneficial in focusing.

In order to achieve the above-mentioned object, according to the present invention, there is provided a lens apparatus including: a lens unit configured to be movable for flange back adjustment; a driving device configured to drive the lens unit; a position detector configured to detect a position of the lens unit; a state detector configured to detect a state of the lens apparatus; a memory configured to store a first state detected by the state detector at a time when the flange back adjustment is performed; and a controller configured to control the driving device based on the first state, a second state of the lens apparatus detected by the state detector, and the position of the lens unit detected by the position detector.

According to the present invention, the lens apparatus that is advantageous for focusing, for example, can be provided.

Further features of the present invention will become apparent from the following description of exemplary embodiments with reference to the attached drawings.

### BRIEF DESCRIPTION OF THE DRAWINGS

FIG. 1 is a schematic diagram of a configuration of a lens apparatus according to a first embodiment of the present invention.

FIG. 2 is a flow chart of processing of the lens apparatus according to the first embodiment of the present invention.

FIG. 3 is a flow chart of processing of the lens apparatus according to the first embodiment of the present invention.

### DESCRIPTION OF THE EMBODIMENTS

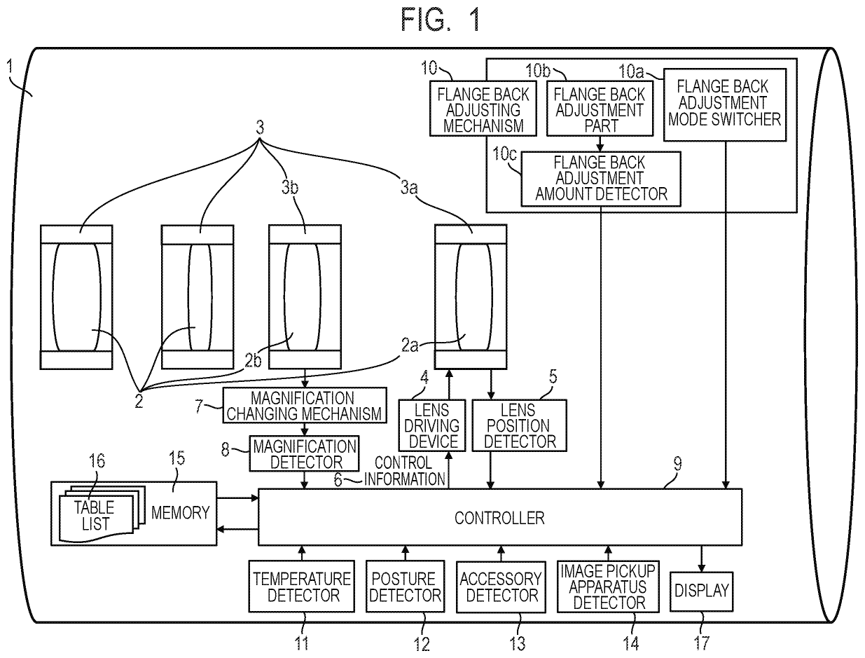

Now, exemplary embodiments of the present invention are described based on an embodiment illustrated in FIG. 1 to FIG. 3.

### First Embodiment

FIG. 1 is a schematic diagram for illustrating a configuration of a lens apparatus to which the present invention is applied.

A lens apparatus 1 includes a plurality of lens units 2 and lens barrels 3 configured to house the lens units 2. The lens units 2 include an imaging optical system 2a and a magnification changing optical system (magnification lens unit) 2b.

The imaging optical system 2a is movable in an optical axis direction integrally with an imaging lens barrel 3a, and is configured to move in the optical axis direction to change a back focus. A lens driving device 4 is configured to move the imaging optical system 2a and the imaging lens barrel 3a in the optical axis direction. A lens position detector 5 is configured to detect a position of the imaging lens barrel 3a, to thereby detect a position in the optical axis direction of the imaging optical system 2a. The lens driving device 4 is configured to adjust the position in the optical axis direction with control information 6 based on information from the lens position detector 5. A magnification changing lens barrel 3b housing the magnification changing optical system 2b is configured to be switched between insertion and retraction (insertion and removal) into and from an optical path by a magnification changing mechanism 7, to thereby switch a magnification (focal length range) of the lens apparatus 1. The magnification changing mechanism 7 includes a magnification detector (state detector) 8 configured to detect the switching of the magnification, and is configured to detect a position (insertion or removal state) of the magnification changing optical system 2b, and notify a controller 9 of the state.

The lens apparatus 1 includes a flange back adjusting mechanism 10 to be used by a user to adjust a flange back. The flange back adjusting mechanism 10 is formed of a flange back adjustment mode switcher 10a, a flange back adjustment part lob, and a flange back adjustment amount detector 10c. The flange back adjustment mode switcher 10a is configured to have a detected value of A at a time of start of operation for the flange back adjustment, and a detected value of B at a time of completion of the adjustment. The flange back adjustment amount detector 10c is configured to detect an operation amount of the flange back adjustment part 10b at the time when the flange back adjustment mode switcher 10a has the detected value of A. The flange back adjustment amount detector 10c is connected to the controller 9 included in the lens apparatus 1. The controller 9 is configured to calculate a movement amount of the imaging optical system 2a based on the detected value of the flange back adjustment amount detector 10c, and transmit the control information 6 to the lens driving device 4.

The lens apparatus 1 includes a temperature detector 11 configured to detect a temperature inside the lens apparatus, a posture detector 12 configured to detect a lens posture, an accessory detector 13 configured to detect an accessory attached, and an image pickup apparatus detector 14 configured to detect an image pickup apparatus to be attached. The lens apparatus 1 also includes a memory 15 configured to store a detected value of the magnification detector 8, the detected value of the flange back adjustment amount detector 10c, a detected value of the temperature detector 11, a detected value of the posture detector 12, a detected value of the accessory detector 13, and a detected value of the image pickup apparatus detector 14. The memory 15 includes a table list 16. The table list 16 includes a plurality of data tables to be used by the controller 9 to generate the control information 6 when the state of the lens apparatus 1 has changed. The lens apparatus 1 further includes a display 17 configured to visually display whether a distance of the back focus is appropriate.

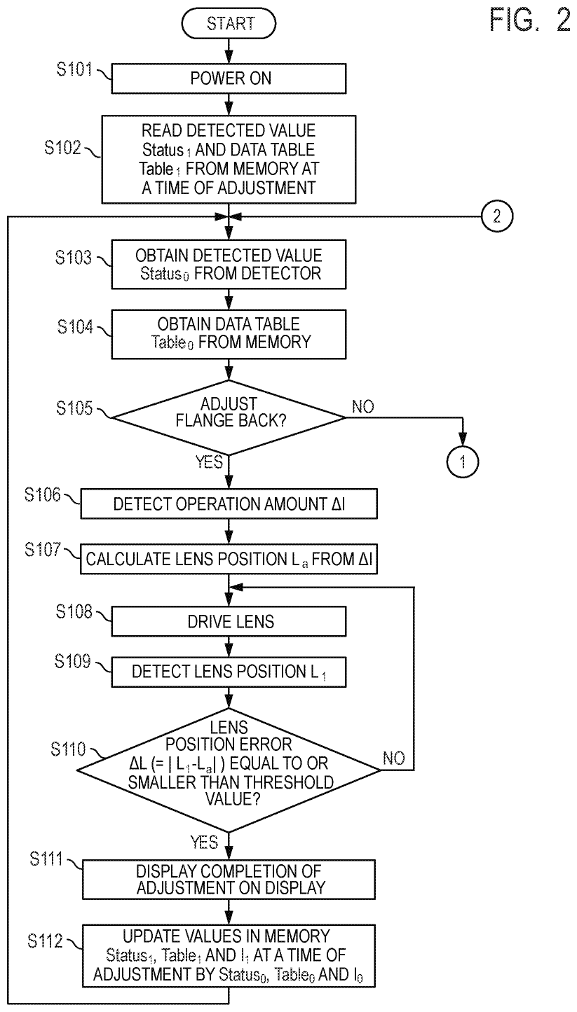

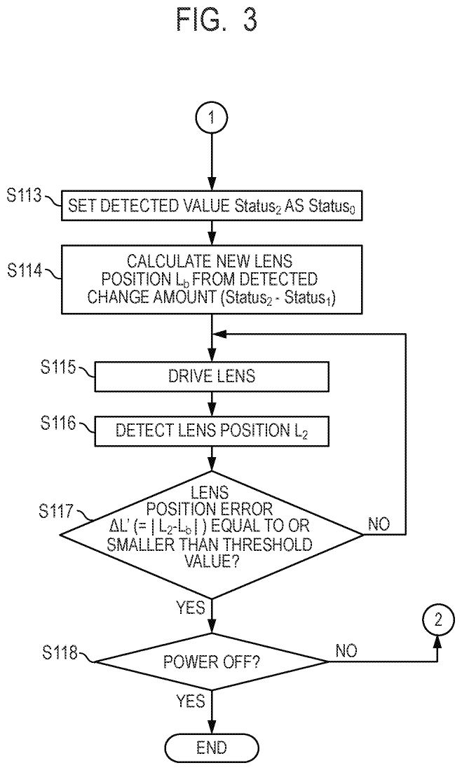

Flows of sending and receiving of data in the lens apparatus according to the first embodiment are described with reference to flow charts of FIG. 2 and FIG. 3.

In the first embodiment, the temperature detector (state detector) 11 detects a temperature T the posture detector (state detector) 12 detects a lens posture P, the accessory detector (state detector) 13 detects an attached accessory A, the magnification detector (state detector) 8 detects a magnification value E, and the image pickup apparatus detector (state detector) 14 detects an image pickup apparatus C. The temperature T, the lens posture P, the attached accessory A, the magnification value E, and the image pickup apparatus C are collectively referred to as “Status.”

In FIG. 2, when the image pickup apparatus is powered ON under a state in which the lens apparatus 1 is attached to the image pickup apparatus (Step S101), a detected value (first state) Status₁ at the time of the last flange back adjustment and a data table Table₁, which are stored in the memory 15, are obtained by the controller 9 (Step S102). The data table Table₁ has stored therein data indicating a relationship between a difference between the detected value Status₁ at the time of the flange back adjustment and a detected value (second state) Status₂ at the time of videography (image pickup) and the position (or position correction amount) of the imaging optical system 2a, and has stored therein parameters required for calculating the position (or position correction amount) of the imaging optical system 2a based on the difference.

Next, a detected value Status₀ of each detector is obtained by the controller 9 (Step S103). Subsequently, the controller 9 obtains a data table Table₀ corresponding to the detected value Status₀ from the table list 16 stored in the memory 15 (Step S104). The parameters required for the calculation are different depending on the detected value Status₀, and the controller 9 obtains the data table Table₀ that is appropriate for the detected value Status₀ from among the plurality of data tables included in the table list 16.

Next, the controller 9 obtains the detected value of the flange back adjustment mode switcher 10a of the flange back adjusting mechanism 10 (Step S105). Here, in a case in which the detected value of the flange back adjustment mode switcher 10a is A (a case in which the flange back is to be adjusted), the flange back adjustment amount detector 10c detects a position lo of the flange back adjustment part 10b, and notifies the controller 9 of the position lo (Step S106).

The controller 9 calculates an operation amount ΔI(=|I₀−I₁|) from a position I₁ of the flange back adjustment part 10b at the time of the last adjustment, which is stored in the memory 15, and the current position I₀. Subsequently, the controller 9 calculates a position Lₐ after the movement of the imaging lens barrel 3a from the operation amount ΔI and the lens position L₀ detected by the lens position detector 5 (Step S107), and transmits to the control information 6. The lens driving device 4 moves the imaging optical system 2a in the optical axis direction together with the imaging lens barrel 3a based on the control information 6 (Step S108).

The lens position detector 5 detects a position of the imaging lens barrel 3a after the movement (Step S109).

The controller 9 determines whether an error ΔL (=|L₁−Lₐ|) of the actual position L₁ and the calculated position Lₐ of the imaging lens barrel 3a is equal to or smaller than a threshold value (Step S110). When ΔL is larger than the threshold value, the controller 9 transmits the control information 6 again to the lens driving device 4 to move the imaging optical system 2a in the optical axis direction (Step S108).

In contrast, when ΔL is equal to or smaller than the threshold value, completion of the flange back adjustment is displayed on the display 17 (Step Sill), and Status₁, Table₁, and I₁, which are stored in the memory 15, are updated by Status₀, Table₀, and I₀, respectively (Step S112).

After the values in the memory 15 are updated, the processing returns again to the processing of obtaining the detected value of each detector (Step S103).

A case in which the detected value of the flange back adjustment mode switcher 10a is B (case in which the flange back is not to be adjusted) in the processing (Step S105) is illustrated in FIG. 3.

A value of the detected value Status₂ at the time of videography is set as Status₀ (Step S113). Subsequently, a new lens position L_{b} of the imaging lens barrel 3a is calculated from the detected value Status₂ at the time of videography, the detected value Status₁ at the time of adjustment, and the data table Table₁ (Step S114). The controller 9 transmits the control information 6 based on the new lens position L_{b} to the lens driving device 4. The lens driving device 4 moves the imaging optical system 2a in the optical axis direction based on the control information 6 (Step S115).

The lens position detector 5 detects a position L₂ of the imaging lens barrel 3a after the movement (Step S116), and the controller 9 determines whether an error ΔL′ (=|L₂−L_{b}|) of the actual position L₂ and the calculated position L_{b} of the imaging lens barrel 3a is equal to or smaller than a threshold value (Step S117). When ΔL′ is larger than the threshold value, the controller 9 transmits the control information 6 again to the lens driving device 4. The lens driving device 4 moves the imaging optical system 2a in the optical axis direction based on the control information 6 (Step S115). In contrast, when ΔL′ is equal to or smaller than the threshold value, the processing returns to the processing in which the controller 9 obtains the detected value Status₀ of each detector (Step S103), and the processing of the above-mentioned flow is executed repeatedly until the image pickup apparatus is powered OFF (Step S118).

Behavior in use of the lens apparatus described above is described below.

When an environmental temperature, the lens posture, an adaptor attached to the lens apparatus 1, a position of the magnification changing optical system, and the image pickup apparatus attached are the same conditions as when the lens apparatus 1 is attached to the image pickup apparatus and the flange back adjustment is correctly performed, the lens apparatus 1 is in a state in which the back focus has not changed. Also in a case in which the image pickup apparatus is powered ON again, when the conditions are the same as those at the time of the flange back adjustment, which are stored in the memory 15, the lens apparatus 1 is in the state in which the back focus has not changed.

When at least one condition from among lens states including the temperature, the lens posture, presence or absence and the type of attached adaptor, and the position of the magnification changing optical system has changed from the condition under which the flange back was adjusted, the back focus may be changed. When the back focus is changed, the imaging optical system 2a is moved in the optical axis direction together with the imaging lens barrel 3a by the lens driving device 4 to maintain an appropriate state of the flange back.

As described above, according to the lens apparatus of the first embodiment, even when a significant change in temperature environment or lens posture, a change of the attached adaptor, or a change in position of the magnification changing optical system occurs, the appropriate state of the flange back can be maintained without a readjustment of the flange back by the videographer. As a result, a videography (image pickup) opportunity can be prevented from being lost by the videographer not noticing a focus deviation caused by a change in back focus.

Further, accuracy of the flange back adjustment can be increased, and hence a picture of higher quality can be taken. Further, through provision of the image pickup apparatus detector and storage of the most recent flange back adjustment value corresponding to the image pickup apparatus, the flange back adjustment at the time when the image pickup apparatus is replaced can be omitted.

In the first embodiment, the temperature, the lens posture, the adaptor, and the magnification changing optical system are exemplified as videographic conditions that affect the change in back focus of the lens apparatus, and the detectors for the respective conditions are provided. However, detectors to which the present invention is applicable are not limited thereto. The back focus of the lens apparatus is changed also with a change in humidity or atmospheric pressure, and hence the detectors may be detectors configured to detect the change in humidity and the change in atmospheric pressure.

With an image pickup apparatus including the lens apparatus according to the present invention described above in the first embodiment, and an image pickup element configured to take an image formed by the lens apparatus, the image pickup apparatus having the effects of the present invention can be achieved.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-003660, filed Jan. 14, 2020, which is hereby incorporated by reference herein in its entirety.

What is claimed is:

1. A lens apparatus comprising:
a lens unit configured to be movable for flange back adjustment;
a driving device configured to drive the lens unit;
a position detector configured to detect a position of the lens unit;
a state detector configured to detect a state of the lens apparatus;
a memory configured to store a first state detected by the state detector at a time when the flange back adjustment is performed; and
a controller configured to control the driving device based on the first state, a second state of the lens apparatus detected by the state detector, and the position of the lens unit detected by the position detector.

2. The lens apparatus according to claim 1, wherein the state detector is configured to detect at least one of a temperature, an atmospheric pressure, and a posture of the lens apparatus.

3. The lens apparatus according to claim 1, further comprising a magnification lens unit configured to be inserted into or removed from an optical path of the lens apparatus to change a focal length of the lens apparatus,
wherein the state detector is configured to detect a state of insertion or removal of the magnification lens unit.

4. The lens apparatus according to claim 1, wherein the memory is configured to store data indicating a relation among an amount regarding the first state, an amount regarding the second state, and an amount regarding the position of the lens unit.

5. The lens apparatus according to claim 4, wherein the controller is configured to obtain the amount regarding the position of the lens unit from the memory based on the amount regarding the first state and the amount regarding the second state.

6. An image pickup apparatus comprising:
a lens apparatus comprising:
a lens unit configured to be movable for flange back adjustment;
a driving device configured to drive the lens unit;
a position detector configured to detect a position of the lens unit;
a state detector configured to detect a state of the lens apparatus;
a memory configured to store a first state detected by the state detector at a time when the flange back adjustment is performed; and
a controller configured to control the driving device based on the first state, a second state of the lens apparatus detected by the state detector, and the position of the lens unit detected by the position detector; and
an image pickup element configured to pick up an image formed by the lens apparatus.
